(19) United States
(12) Patent Application Publication
(10) Pub. No.: US 2008/0256052 A1
(43) Pub. Date: Oct. 16, 2008

(54) METHODS FOR DETERMINING HISTORICAL EFFICACY OF A DOCUMENT IN SATISFYING A USER'S SEARCH NEEDS

(75) Inventors: Gautam Kar, Yorktown Heights, NY (US); Jonathan Lenchner, North Salem, NY (US); Gopal S. Pingali, Mohegan Lake, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/735,725

(22) Filed: Apr. 16, 2007

(51) Int. Cl. G06F 17/30

(52) U.S. Cl. 707/5; 707/E17.017

(57) ABSTRACT

Documents returned by a search engine may be good keyword matches to the search query terms, but may not historically have been very effective in addressing user needs. Documents which have historically been effective in addressing user needs are said to have high efficacy. Disclosed are methods that try to assess the beginning and ending of user search sessions, assume that documents that are the last document looked at are those with the highest efficacy, and incorporate this notion of efficacy in returning-search results.

### BACKGROUND

The present invention relates to information retrieval and, in particular to search applications.

Documents returned by a search engine may be good keyword matches to the search query terms, but the documents may not historically have been very effective in addressing user needs. This problem may be referred to as an “efficacy problem”. On the World Wide Web, this problem is typically solved by using some variant of the PageRank system, in which the number of times other documents point to a given document provides a good indicator of efficacy. Search engines typically combine PageRank with keyword matching to determine overall ranking of documents. However, in some cases, knowledge management systems are populated with documents that have few or even no references to other documents, so the PageRank system is ineffective.

There are systems for ranking items using “stars”, e.g. systems used by Amazon and other e-commerce retailers. These systems rely on an explicit review process to generate “stars” to indicate how satisfied customers have been with, e.g., a purchased item. While these systems are useful for retail customers, they do not solve the “efficacy problem” of document searching described above.

Thus, there is a need to be able to rank documents, incorporating efficacy, i.e. incorporating some sense of how effective documents resumed as search results have historically proven to be in addressing user needs.

### SUMMARY

According to one embodiment, a method is provided for determining historical efficacy of a document, in satisfying a user's search needs based on the last access time of the document in a search session. Entries are kept in a hash table, each entry including information identifying a user, information indicating a last access time for a document, and information identifying a document. A counter keeps track of the number of times the document is the last document looked at in the context, of a search session. An application log containing a record of all searches and document accesses (i.e., documents opened as a result of clicking on an item in the search result list) is sequentially read through, and an entry in the hash table is replaced with a new entry when a new record is encountered for a given user. For a new entry, a determination is made whether the access time in a record just read from the application log exceeds the access time of the record for which the entry in the hash table is being replaced by more than N seconds, where N is a parameter of the system. Reasonable values for N may be 60 or 120. If the access time of the record just read from the application log exceeds the access time of the record for which the entry in the hash table is being replaced by more than N seconds, a determination is made whether the last access was a document read (as opposed to a search). If so, the new entry in the hash table is updated to indicate that the last access was a document, read, and the last document accessed counter for the document is incremented. After all records in the application log file are read, all the entries in the hash table are walked through. If an entry in the hash table indicates that the last access was a document read, the counter for that document is incremented, such that the counter for each document indicates the number of times the document was the document last accessed in the context of a search session. An efficacy score is determined for each document, based on the number of times the document was the last document accessed in the context of a search session, where a “search session” may be defined as a sequence of searches and document accesses unbroken by a period of N seconds. It is also possible to declare that a search session has ended when two successive queries can be judged to have little or no lexical affinity with one another.

According to another embodiment, a method is provided for determining historical efficacy of a document in satisfying a user's search needs based on the last access time of the document and the fraction of time the document is accessed during a search session. Entries are kept, in a hash table, each entry including information identifying a user, information indicating a last access time for a document, and information identifying a document. A first counter keeps track of the number of times the document is the last document looked at in the context of a search session. A second counter keeps track of the number of times the document is accessed in total in the context of the search session. An application log of records of document searches is sequentially read through, and the second counter is incremented for each document accessed during the searches. Also, an entry in the hash table is replaced with a new entry when a new record is encountered for a given user. For a new entry, a determination is made whether the access time in a record just read from the application log exceeds the access time of the record for which the entry in the hash table is being replaced by more than N seconds, where N is again a system parameter. If the access time of the record just read from the application log exceeds the access time of the record for which the entry in the hash table is being replaced by more than N seconds, a determination is made whether the last access was a document read. If so, the new entry in the hash table is updated to indicate that the last access was a document read, and the first counter for the document is incremented. After all records in the application log file are read, all entries in the hash table are walked through. If an entry in the hash table indicates that the last, access was a document read, the first counter for the document identified in that entry is incremented. An efficacy score is calculated by dividing the count of last accesses for a document in the first counter by the count of total accesses of the document in the second counter.

### BRIEF DESCRIPTION OF THE DRAWINGS

Referring to the exemplary drawings, wherein like elements are numbered alike in the several FIGS.:

FIG. 1 is a schematic drawing of an exemplary method for producing efficacy scores for documents in a collection based on the number of times a document is the last document looked at within a search session.

FIG. 2 is a schematic drawing of an exemplary method for producing efficacy scores for documents in a collection based on the percentage of times a document is the last document looked at within a search session.

FIG. 3 is a schematic drawing depicting an exemplary method for combining efficacy scores with keyword matching according to an exemplary embodiment.

FIG. 4 is a schematic drawing depicting an exemplary method for combining a normalized efficacy score and a normalized keyword matching rating to give a combined overall document rating.

### DETAILED DESCRIPTION

According to an exemplary embodiment, the efficacy problem described above (among others) may be solved by observing what documents are opened by a given user in response to a search query. According to one embodiment the last document opened or read by a user during a search session may be considered the most useful Documents that are opened prior to the last document are considered less useful or not useful at all. In the description that follows, the terminology that a document is “accessed,” “opened” or “read” is used with the intended meaning that a document was opened, with the assumption, but not the requirement, that the opened document was actually read. These three terms are used interchangeably. In addition, a “system access” is used to refer either to a user search or a user read (equivalently access/open) of a document, or conceivably any of the myriad of other services that the application provides and logs. In the description that follows, the myriad of possible other logged activities, besides searches and document accesses, is disregarded.

According to an exemplary embodiment, documents are ranked in response to a query. Documents may be ranked in terms of relevancy. Relevancy measures how well the terms in the document match the search terms. The documents may also be ranked in terms of efficacy rating. The greater percentage of times a document is the last document looked at (opened) in response to a search query, the greater the efficacy ranking. The exact manner in which these two rankings are combined is left to the implementer. It is also possible to think about efficacy in terms of the absolute number of times that a document is the last document looked at rather than the percentage of times the document is the last looked at.

In one embodiment, a “star” or “asterisk” system may be used for ranking documents to display based on efficacy. In this embodiment, a star, asterisk, or other symbol may be used, as an indicator of historical efficacy of a document in satisfying a user's search needs. Thus, for example, a document displayed with more stars, e.g., 4 or 5 out of 5, may be considered more often the final document opened in response to a query than a document displayed with fewer stars. There may be a ease in which a document is not ranked via the asterisk system. In this case, efficacy of the document may not be determined based on the number of stars. This case may occur if a document has never appeared in a search result list or perhaps has appeared but has never been, opened.

The advantages of this embodiment are two-fold. On the one hand, efficacy information is provided to the user even in the case where there is no hyperlink or other document cross-referencing information, available in the document collection. On the other hand, even in cases where such information is available (and perhaps even used in lieu, of the suggested efficacy measure), the user is given two independent bits of information, one on how well documents match the query terms, and a second on how effective the documents have been in satisfying user needs in the past, rather than combining this information as in conventional search solutions.

In another embodiment, efficacy is combined with relevancy, using some weighting system to give the final rank, or ordered list of documents, returned in response to the search.

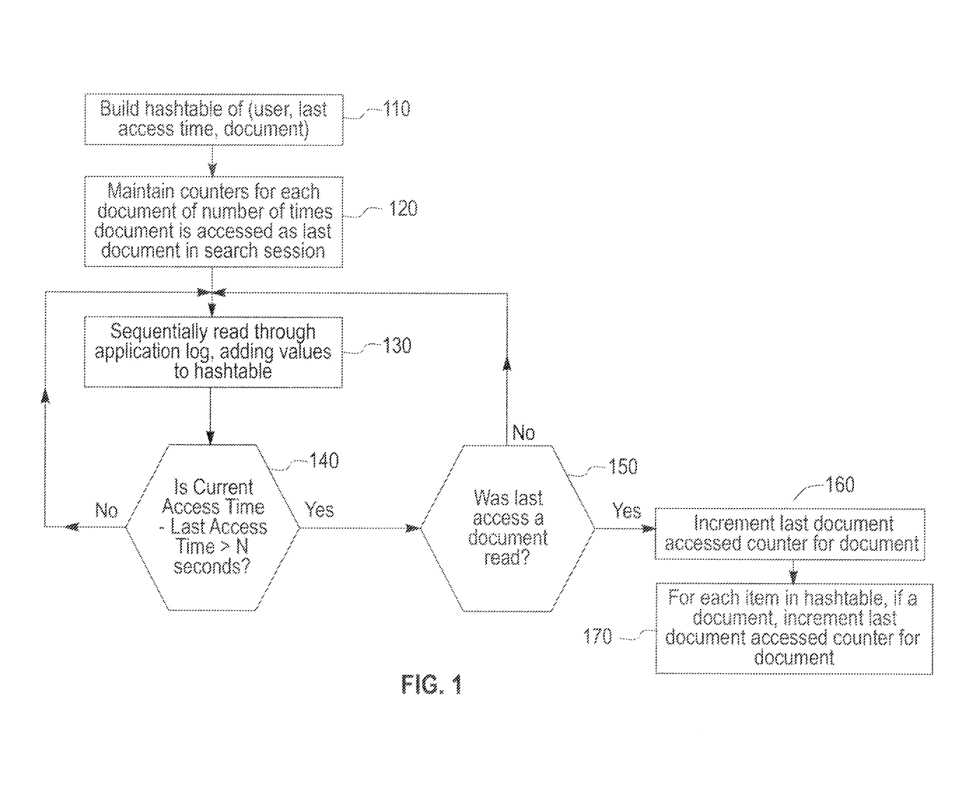

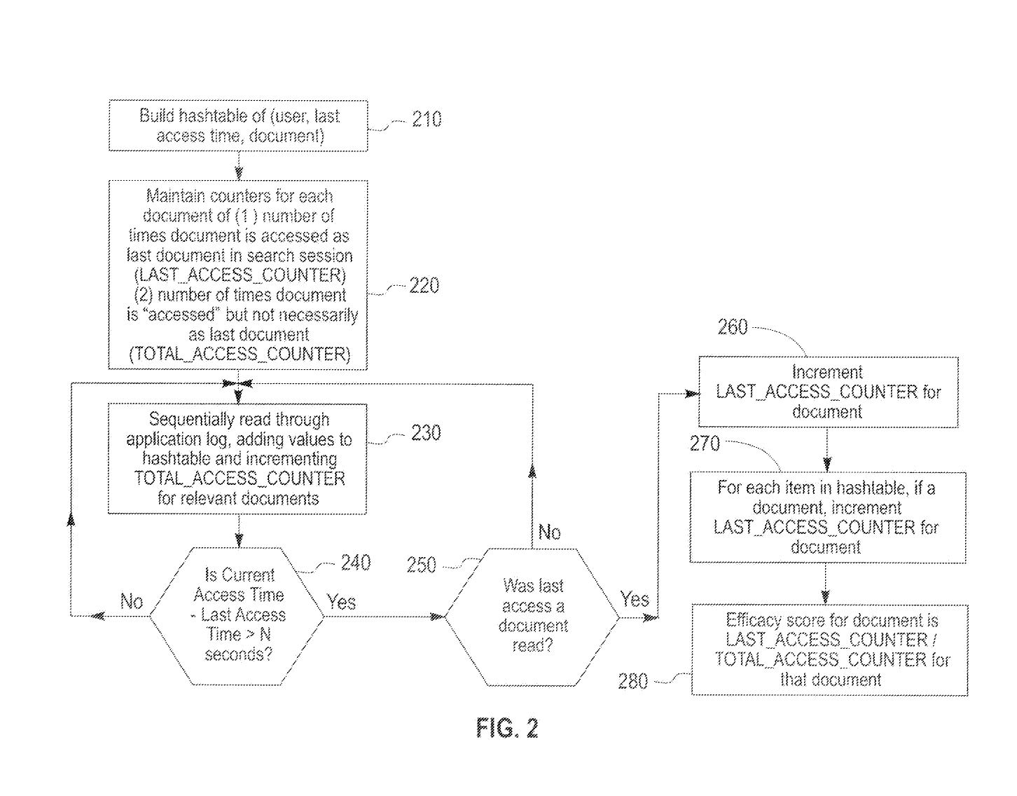

One of the assumptions underlying this computation of efficacy scores in FIGS. 1 and 2, and the combining of efficacy scores and keyword match scores in subsequent figures, is that there is an application that is utilizing a keyword search, has knowledge of who the users are (not necessarily their identity, but at least can distinguish individual users using a cookie), and records details of all search related activities in some form of log. Thus, it records the user identity (or some proxy for the user as obtained, for example, from a user's session cookie), search query terms submitted, documents in an ordered search result lists, when users click on a document to open it, and so forth.

FIG. 1 illustrates an exemplary process for computing an efficacy score based on the raw count of the times the document is the last document looked at in the context of a search session. A search session is a session involving queries and reading of documents to satisfy a particular search need. Without asking the user to indicate when a particular search session begins and ends, a more heuristic approach is needed. In the case, as described and illustrated, a search session may be considered to be over when no further action is taken inside the search application for a period of N seconds, where N is a system-determined parameter. Reasonable values for N are, e.g., 60 or 120. Other methods for assessing the beginning and end of a search session may also be used. For example, one could use a combination of an N second threshold, but allow search sessions to continue even if the N second threshold is surpassed, if the user later selects an item from the result, list of a prior search. One could also try to assess when successive search terms no longer have any real lexical affinity to one another.

With the efficacy score computation as depicted in FIG. 1, the process begins at step 110 at which a hash table is initialized. The hash table includes a tuple of the form (user, last access time, document) or more formally (user, (last access time, document)). The hash table key is the user, and the value is a (last access time, document) pair. In step 120, counters for each document are initialized, giving the number of times the document is the last document looked at in the context of a search session. In step 130 the application log is sequentially read through. Each time a new entry is encountered for a given user, an entry is added to the hash table created in step 110. If an entry exists in the hash table for the given user, the old entry is replaced with the new entry. The document element is left null unless the action indicated in the log is the read of a document. Alternatively, the action could be the submission of new search terms. At the point of adding the hash table entry, the question is asked in step 140 of whether the access time in the record just read from the log exceeds the access time of the record it is replacing by more than N seconds, where, as noted above, N is a system-defined parameter. If there is no record being replaced the answer should always be No. If the answer is no, the next record is read from the log. If; on the other hand, the answer is yes, then the further question is asked, in step 150, whether the last access was a document read? The easiest way to answer this question is to test if the document in the (last access time, document) pair that is being replaced in the hash table is not null. If the value in the hash table is null, then the answer to the question in step 150 is no, and control returns to step 130 and another read from the log file. On the other hand, if the answer is yes, then control passes to step 160 where we increment the last document accessed counter for the document. Finally, after all lines in the log file are read, control passes to step 170 for end of loop processing. In this step, all records in the hash table initialized in step 110 are walked through, if an element in the hash table has a not null, document in its (last access time, document) value pair, then the last document accessed counter is incremented for the given document. At the end of all processing, the counter for each document counts the number of times the document was the “last accessed” using the heuristic that a document is assumed to be last accessed if there is a gap of N seconds between its access and any further activity by the same user as indicated in the log.

FIG. 2 illustrates a process for computing an efficacy score based on the percentage of times the document is the last document looked at in the context of a search session. The process for computing efficacy scores in this way is similar to the process for computing efficacy scores based on the raw count of the times the document is the last document looked at (FIG. 1), but with a few additional steps.

The process shown in FIG. 2 starts at step 210 at which a hash table is initialized. The hash table includes a tuple of the form (user, last access time, document) or more formally (user, (last access time, document)). The hash table key is the user and the value is a (last access time, document) pair. In step 220, two counters are initialized for each document, one, LAST_ACCESS_COUNTER, gives the number of times the document is the last document looked at in the context of a search session and another, TOTAL_ACCESS_COUNTER, which gives the total number of times the document is “accessed” but not necessarily as the last document within the search session. There are several important notes regarding handling of the TOTAL_ACCESS_COUNTER. First, if a document is accessed several times within a given session, the TOTAL_ACCESS_COUNTER for that document is only incremented once. Secondly, even if a document is not actually opened or looked at but appears as one of the top, e.g., three results in a search result list, the document may be considered as having been accessed. The number three is a somewhat arbitrary, system specified parameter. In order to make such a determination the application must log at least the top results returned in response to user search requests. In step 230, the application log is sequentially read through. Each time a new entry is encountered for a given user, an entry is added to the hash, table created in step 210, and the TOTAL_ACCESS_COUNTER for the relevant document or documents is updated as described above. If an entry already exists in the hash table for the given user, the old entry is replaced with the new entry. The document element is left null unless the action indicated in the log is the read of a document. At the point of adding the hash, table entry, the question is asked as in step 240 of whether the access time in the record just read from the log exceeds the access time of the record it is replacing by more than N seconds, where, as noted earlier, N is a system-defined parameter. If there is no record being replaced the answer should always be no. If the answer is no, the next record is read from the log. If, on the other hand, the answer is yes, then the further question is asked, in step 250, whether the last access was a document read? The easiest way to answer this question is to test if the document in the (last access time, document) pair that is being replaced in the hash table is not null. If the value in the hash table is null, then the answer to the question in step 250 is no, and control returns to step 230 and another read from the log file. On the other hand, if the answer is yes, then control passes to step 260 where we increment LAST_ACCESS_COUNTER for the document. Finally, after all lines in the log file are read, control passes to steps 270 and 280 for end of loop processing. In step 270, all records in the hash table initialized in step 210 are walked through. If an element in the hash table has a not null document in its (last access time, document) value pair, then LAST_ACCESS_COUNTER is incremented for the given document. Finally, in step 280 the percentage of time in which each document is actually the last accessed within the various search sessions is computed by taking the efficacy score for that document to be LAST_ACCESS_COUNTER/TOTAL_ACCESS_COUNTER for the document.

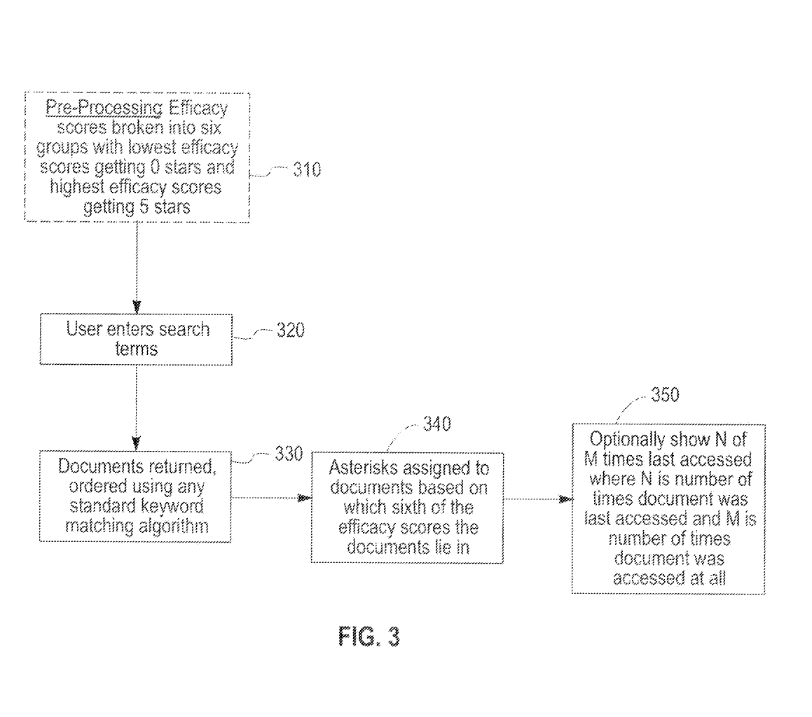

In FIG. 3, an exemplary process for combining keyword matching and efficacy scores using an asterisk system is shown. The asterisk, system is similar in spirit to that used by Amazon, eBay and numerous other e-commerce retailers to rate their products, or allow their customers to rate their products. The process assumes in its pre-processing step 350, that efficacy scores for all documents have been computed, using either the method portrayed in FIG. 1 or FIG. 2, and that they are broken into six buckets, ranging from a zero star bucket containing those documents which have the lowest efficacy rating to a five star bucket for those documents which have the highest efficacy rating. If one uses the percent system (FIG. 2) it is possible for a document to be in no bucket at all, e.g., if the document has never been accessed, i.e. if the document's TOTAL_ACCESS_COUNTER=0. Thus, the user interface should somehow distinguish between the cases of zero stars and “not rated.” It is obviously possible to have the asterisk system go from one to five stars rather than zero to five, or to pick a maximum number of stars different from live. In the first step, which is not a pre-processing step 320, the user enters search terms into a search interface. In step 330 the documents are returned, ranked in the order specified by a keyword matching process. One ski lied in the art will appreciate that any one of a number of keyword matching processes may be used, including those using some form of tf×idf (term frequency times inverse document frequency) for this purpose. The details of one such, keyword matching process are given in Salion et al, “Term-Weighting Approaches in Automatic Text. Retrieval”, Information Processing and Management, Vol. 24, No, 5, pp. 513-523, 1988. In step 340, the documents returned from the keyword matching process are displayed in an order determined solely by keyword matching. Additionally, depending on which group the documents belong to based on step 310, a variable number of asterisks, stars, or other symbol are displayed along with the document. Then, in the optional step 350, in addition to the asterisks, if the percentage process depicted in FIG. 2 is used for determining efficacy, then one may additionally display information of the form “(N of M times last accessed)” where N=LAST_ACCESS_COUNTER, M=TOTAL_ACCESS_COUNTER.

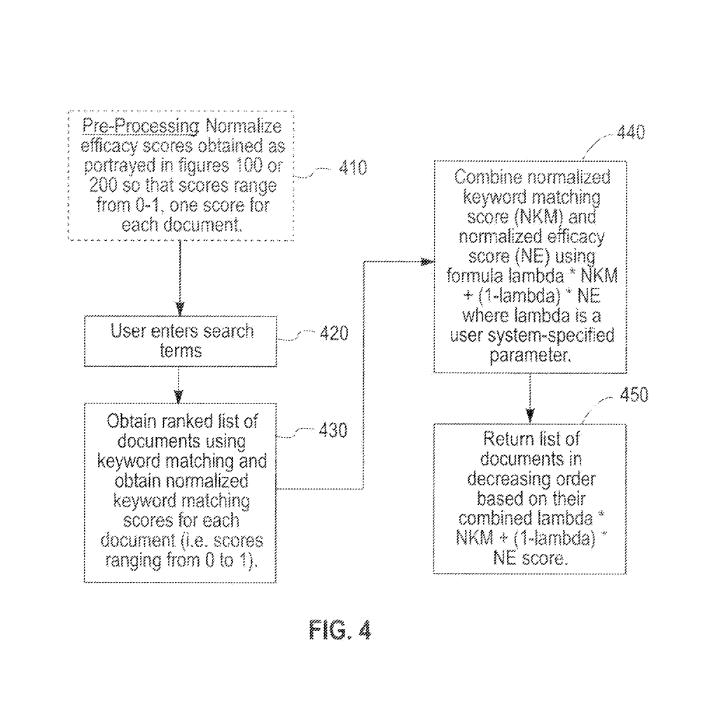

In FIG. 4, a system for combining keyword ranking and efficacy scores using a weighted average of the two to determine the final ordered document list returned in response to a search is depicted. In the pre-processing step, step 410, either the efficacy computation using raw counts, depleted in FIG. 1, or the efficacy computation using percentages, (depicted in FIG. 2), is performed. The percentage computation is already normalized, but if the efficacy computation is performed using raw counts, the efficacy numbers must next be normalized to lie in the range 0 to 1. In the first, non-pre-processing step, step 420, the user enters their search terms. In step 430, keyword matching is performed, and a ranked list of documents is fetched with keyword matching scores, which are then normalized so that the values fail in the range 0 to 1. Then, in step 440, the keyword matching score for each document returned is combined with the document's normalized efficacy score using a weighted average of the two via the formula TOTAL_SCORE=lambda*NORMALIZED_KEYWORD_MATCHING+(1−lambda)*NORMALIZED_EFFICACY where lambda is a system-specified parameter. In the range 0≦lambda≦ 1. A choice of lambda near 0 means the documents will be ranked more in line with the efficacy ranking, while a choice of lambda closer to 1 means that the documents will be ranked more in line with the keyword matching ranking. Finally, in step 450 the system outputs the new ordered list in terms of decreasing TOTAL_SCORE.

According to one embodiment, it is possible to incorporate both of the methods of FIGS. 3 and 4. In other words, one could have the efficacy score influence the result list order as in FIG. 4 while also displaying asterisks as in FIG. 3 to give the user a precise sense of the efficacy of each document, and optionally include the “(N of M times last accessed)” information.

While the invention has been described with reference to exemplary embodiments, it will, be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for determining historical efficacy of a document in satisfying a user's search needs, the method comprising:
initializing a hash table with entries, each entry including information identifying a user, information indicating a last access time for a document, and information identifying a document;
initializing a counter for each document, the counter giving the number of times the document is the last, document looked at in the context, of a search session;
sequentially reading through an application log of records of document searches;
adding an entry to the hash table each time a new record is encountered in the application, log for a given user, wherein if an entry already exists in the hash table for the user, the entry is replaced with information contained in the new record;
if there is no entry in the hash table being replaced, returning to the step of sequentially reading through the application log to read the next record from the application log;
if an entry in the hash table is being replaced, determining whether the access time in a record just read from the application log exceeds the access time of the record for which the entry in the hash table is being replacing by more than N seconds, where N is an integer;
if the entry in the hash table is being replaced but the access time in the record just read from the application log does not exceed the access time of the record for which the entry in the hash table is being replaced by more than N seconds, returning to the step of sequentially reading through the application log;
if the access time of the record just read from the application log exceeds the access time of the record for which the entry in the hash table is being replaced by more than N seconds, determining whether the last access was a document read;
if the last access was a document read, updating the new entry to indicate that the last access was a document read, incrementing the last document accessed content for the document and returning to the step of sequentially reading through the application log:
if the last access was not a document read, returning to the step of sequentially reading through the application log;
after all records in the application log file are read, walking through all entries in the hash table, and, if an entry in the hash table indicates that the last access was a document read, incrementing the counter for that document, such that the counter for each document indicates the number of times the document was the document last accessed in the context of a search session; and
determining an efficacy score for each document based on the count of the number of times the document was the document last accessed in the context of a search session.

2. The method of claim 1, further comprising:
grouping documents into efficacy rating groups based on the efficacy scores;
receiving a search term from a user via a search user interface;
returning documents, ranked in an order based on keyword matching; and
displaying the returned ranked documents along with indications of the efficacy score for each document, wherein the indications are based on the efficacy rating groups of the documents.

3. The method of claim 1, further comprising:
normalizing the efficacy scores to range from 0 to 1, with one score for each document;
receiving a search term from a user via a search user interface;
returning documents, ranked in an order based on keyword matching;
determine keyword matching scores for each document, wherein the keyword matching scores are normalized so that the values tall in the range 0 to 1;
combining the keyword matching score for each document with the normalized efficacy score for each document, using a weighted average to produced a combined score for each document; and
returning the list of documents ranked in decreasing based on the combined score.

4. A method for determining historical efficacy of a document in satisfying a user's search needs, the method comprising:
initializing a hash table with entries, each entry including information identifying a user, information indicating a last access time for a document, and information identifying a document;
initializing a first counter with a count for each document, of the number of times the document is the last document looked at in the context of a search session;
initializing a second counter with a count for each document of the number of times the document is accessed in total in the context of the search session;
sequentially reading through an application log of records of document searches and incrementing the second counter for each document accessed during the searches;
adding an entry to the hash table each time a new record is encountered in the application log for a given user, wherein if an entry already exists in the hash table for the user, the entry is replaced with information contained in the new record;
if there is no entry in the hash table being replaced, returning to the step of sequentially reading through the application, log to read the next record from the application log;
if an entry in the hash table is being replaced, determining whether the access time in a record just read from the application log exceeds the access time of the record for which the entry in the hash table is being replacing by more than N seconds, where N is an integer;
if the entry in the hash table is being replaced but the access time in the record just read from the application log does not exceed the access time of the record for which the entry in the hash table is being replaced by more than N seconds, returning to the step of sequentially reading through the application log;
if the access time of the record just read from the application log exceeds the access time of the record for which the entry in the hash table is being replaced by more than N seconds, determining whether the last access was a document read;
if the last access was a document read, updating the new entry in the hash table to indicate that the last access was a document read, incrementing the first counter for the document, and returning to the step of sequentially reading through the application log;
if the last access was not a document read, returning to the step of sequentially reading through the application log; and
after all records in the application log file are read, walking through all entries in the hash table, and, if an entry in the hash table indicates that the last access was a document read, incrementing the first counter for the document identified in that entry; and
calculating an efficacy score by dividing the count of last accesses for a document in the first counter by the count of total accesses of the document in the second counter.

5. The method of claim 4, further comprising:
grouping documents into efficacy rating groups based on the efficacy scores;
receiving a search term from a user via a search user interface;
returning documents, ranked in an order based on keyword matching;
displaying the returned ranked documents along with indications of the efficacy score for each document, wherein the indications are based on the efficacy rating groups of the documents; and
displaying information indicating the number of times the document was accessed as the last document as a percentage of the total number of times the document was accessed.

6. The method of claim 4, further comprising:
normalizing the efficacy scores to range from 0 to 1, with one score for each document;
receiving a search term from a user via a search user interface;
returning documents, ranked in an order based on keyword matching;
determine keyword matching scores for each document, wherein the keyword matching scores are normalized so that the values fall in the range 0 to 1;
combining the keyword matching score for each document with the normalized efficacy score for each document using a weighted average to produce a combined score for each document; and
returning the list of documents ranked in decreasing order based on the combined score.
